(19) United States
(12) Patent Application Publication
(10) Pub. No.: US 2005/0189498 A1
(43) Pub. Date: Sep. 1, 2005

(54) Irradiation apparatus

(75) Inventors: Adrian Wing Fai Lo, Hsinchu (TW); Hong-Shi Cao, Kaohsiung (TW); Jung-Tsung Hsu, Hsinchu (TW); Ming-I Lee, Taipei (TW); Chin-Tin Chen, Taipei (TW); Chih-Wei Ho, Miaoli (TW)

Correspondence Address: QUINTERO LAW OFFICE, 1617 BROADWAY, 3RD FLOOR, SANTA MONICA, CA, 90404, US

(73) Assignees: Industrial Technology Research Institute; National Taiwan University Medical Center

(21) Appl. No.: 10/639,035

(22) Filed: Aug. 12, 2003

(30) Foreign Application Priority Data
Dec. 31, 2002 (TW) 91138115

(51) Int. Cl. G21G 5/00

(52) U.S. Cl. 250/492.1

(57) ABSTRACT

An irradiation apparatus for a photodynamic treatment. The irradiation apparatus includes a main body, a high power light emitting element, an optical lens assembly and an optical fiber. The high power light emitting element is disposed on the main body to output light. The optical lens assembly is adjacent to the high power light emitting element and disposed on the main body to receive the light from the high power light emitting element. The optical fiber has an input end and an output end. The input end is coupled to the optical lens assembly to receive and transmit the light from the optical lens assembly.

### BACKGROUND OF THE INVENTION

1. Field of the Invention

The present invention relates to an irradiation apparatus, and in particular to an irradiation apparatus that enhances the irradiation energy of the light output therefrom.

2. Description of the Related Art

Generally speaking, various irradiation treatment apparatuses are employed in a photodynamic treatment to kill cancer cells in a human body. The irradiation source of a conventional irradiation treatment apparatus is no more than a traditional lamp, a traditional light emitting diode (LED), a traditional laser source or a semiconductor laser source.

Nevertheless, conventional irradiation sources have many drawbacks. Traditional light sources such as tungsten, incandescent and halogen lamps have low energy conversion efficiency. As a result, these light sources consume generate a large amount of heat but output little light, thereby requiring additional heat-dissipating devices to dissipate the heat. Traditional LEDs consume little energy, but also produce low levels of light energy. In order to raise the light energy to levels required by many irradiation applications, multiple traditional LEDs are generally arranged in arrays. Multiple traditional LEDs arranged in arrays, however, takes up substantial physical space which can cause complications to the design of the irradiation treatment apparatus.

Similarly, a semiconductor laser source emits light having low total irradiation energy. Moreover, the semiconductor laser source is very expensive. As with the traditional lamp, the traditional laser source requires additional heat-dissipating devices to dissipate the heat generated thereby. The traditional laser sources deliver higher irradiation power, but they are very expensive and generally possess short lifetime.

Hence, there is a need to provide an innovative irradiation apparatus for a photodynamic treatment to overcome the problems of the conventional irradiation is treatment apparatuses. The irradiation apparatus includes a light source that consumes less electricity, generates less heat, and emits light having higher irradiation energy than the traditional irradiation apparatus. Meanwhile, the high irradiation energy of the light is maintained by an optical lens assembly.

### SUMMARY OF THE INVENTION

Accordingly, an object of the invention is to provide an irradiation apparatus for a photodynamic treatment. The irradiation apparatus comprises a main body, a high power light emitting element, an optical lens assembly and an optical fiber. The high power light emitting element is housed in the main body to deliver output light. The optical lens assembly is adjacent to the high power light emitting element and disposed on the main body to receive the light from the high power light emitting element. The optical fiber has an input end and an output end. The input end is coupled to the optical lens assembly to receive and transmit the light from the optical lens assembly.

Preferably, the high power light emitting element consists of one or more high power semiconductor light emitting diode which are designed to be driven at high electrical current of much higher than 100 mA per light emitting device. Some designs can be driven at many Amperes per device. This is significantly higher than the per-device driving current of typically few tens milli-Ampere for traditional light emitting diodes.

Preferably, the irradiation apparatus further comprises a reflector disposed beside the high power light emitting element to reflect the light from the high power light emitting element.

Preferably, the optical lens assembly further comprises a first condenser lens and a second condenser lens. The first condenser lens is adjacent to the high power light emitting element, and the second condenser lens is adjacent to the first condenser lens.

Preferably, the optical lens assembly further comprises a first convex lens adjacent to the second condenser lens to increase the light-receiving range of the optical fiber.

Preferably, the first condenser lens and second condenser lens are aspheric condenser lenses.

Preferably, the first convex lens is a semi-spherical lens.

Preferably, the irradiation apparatus further comprises a second convex lens coupled to the output end of the optical fiber to concentrate the light from the optical fiber.

Preferably, the second convex lens is a spherical lens. Preferably, the irradiation apparatus further comprises a heat-dissipating element disposed on the main body.

Accordingly, the high power light emitting element further comprises a leadframe which has a first leadframe part and a second leadframe part (shown in schematic diagram FIG. 4 as parts 12 and 14), a high power semiconductor light emitting diode die and a packaging element. The high power semiconductor light emitting diode die is disposed on the first leadframe part and connected to the second leadframe part by means of a wire. The packaging element seals the high power semiconductor light emitting diode die and the leadframe parts.

Preferably, the leadframe is made of copper, iron, copper-based alloy and iron-based alloy.

Preferably, the high power light emitting element further comprises a conductive adhesive layer disposed between the first leadframe part and high power semiconductor light emitting diode die.

Preferably, the conductive adhesive layer is made of silver, gold, aluminum, nickel, tin, lead or alloy thereof.

Accordingly, the high power light emitting element further comprises a printed circuit board, a high power semiconductor light emitting diode die and a packaging element. The printed circuit board has a conductive circuit and a reflective surface. The high power semiconductor light emitting diode die is disposed on the printed circuit board and connected to the conductive circuit. The packaging element seals the high power semiconductor light emitting diode die and printed circuit board.

Accordingly, the high power light emitting element 10 further comprises a substrate, a high power semiconductor light emitting diode die and a packaging element. The substrate has a conductive circuit and a reflective wall. The reflective wall and the conductive circuit are formed by deposition on the substrate. The high power semiconductor light emitting diode die is disposed on the substrate and connected to the conductive circuit. The packaging element seals the high power semiconductor light emitting diode die and part of the substrate.

Preferably, the packaging element is made of epoxy compound, silicon dioxide compound or colloid.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view showing the irradiation apparatus of the first embodiment of the invention;

FIG. 2 is a schematic view showing the irradiation apparatus of the second embodiment of the invention;

FIG. 3 is a schematic view showing the irradiation apparatus of the third embodiment of the invention;

FIG. 4 is a schematic view showing a high power light emitting element employed in the present irradiation apparatus; and

FIG. 5 is a schematic view showing another high power light emitting element employed in the present irradiation apparatus.

### DETAILED DESCRIPTION OF THE INVENTION

### Embodiments

### First Embodiment

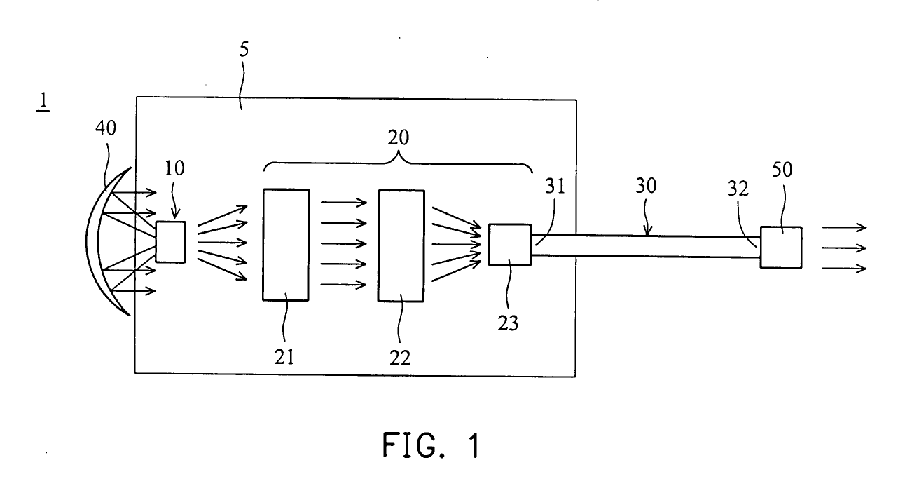

Referring to FIG. 1, the irradiation apparatus 1 comprises a main body 5, a high power light emitting element 10, an optical lens assembly 20 and an optical fiber 30. The high power light emitting element 10 is disposed on the main body 5. The optical lens assembly 20 is adjacent to the high power light emitting element 10 and disposed on the main body 5. The optical fiber 30 has an input end 31 and an output end 32. The input end 31 is coupled to the optical lens assembly 20.

The optical lens assembly 20 includes a first condenser lens 21, a second condenser lens 22 and a first convex lens 23. The first condenser lens 21 is adjacent to the high power light emitting element 10. The second condenser lens 22 is adjacent to the first condenser lens 21. The first convex lens 23 is adjacent to the second condenser lens 22. Meanwhile, the first convex lens 23 of the optical lens assembly 20 is coupled to the input end 31 of the optical fiber 30.

In addition, a reflector 40 is disposed beside the high power light emitting element 10, and a second convex lens 50 is coupled to the output end 32 of the optical fiber 30.

In this embodiment, the high power light emitting element 10 is a high power semiconductor light emitting diode (LED). The high power semiconductor LED 10 has many advantages such as low electricity consumption, low heat generation and high irradiation energy. Specifically, the wavelength and irradiation energy of the light output from the high power semiconductor LED 10 are approximately 630 nm and 300 mW, respectively. Given the fact that the irradiation energy of the light output from a general LED is approximately 5-10 mW. The irradiation energy of the light output from the high power semiconductor LED 10 is much greater than that from the general LED. Furthermore, the irradiation area of the high power semiconductor LED 10 is several times that of the general LED.

In addition, the first condenser lens 21 and second condenser lens 22 are aspheric condenser lenses to concentrate the light output from the high power semiconductor LED 10. The first convex lens 23 is a semi-spherical lens to increase the numerical aperture of the optical fiber 30. The second convex lens 50 is a spherical lens to concentrate the light output from the optical fiber 30.

As shown in FIG. 1, light emitted from the high power semiconductor LED enters the optical lens assembly 20 directly and by reflected off the reflector 40. Some of the light is dispersed before entering the first condenser lens 21. The portion of light managed to enter the first condenser lens 21 (aspheric condenser lens) is collimated and subsequently enters the second condenser lens 22 (aspheric condenser lens) through which the light is further concentrated. The concentrated light is received by the input end 31 of the optical fiber 30 and transmitted through the optical fiber 30.

Nevertheless, the input end 31 of the optical fiber 30 is coupled to the first convex lens 23 (semi-spherical lens) to increase the numerical aperture of the optical fiber 30, such that the light-receiving range of the input end 31 of the optical fiber 30 is increased. The light output from the output end 32 of the optical fiber 30 is coupled to the second convex lens 50 (spherical lens) to further concentrate the light for photodynamic treatment.

### Second Embodiment

Elements corresponding to those shown in FIG. 1 are given the same reference numerals.

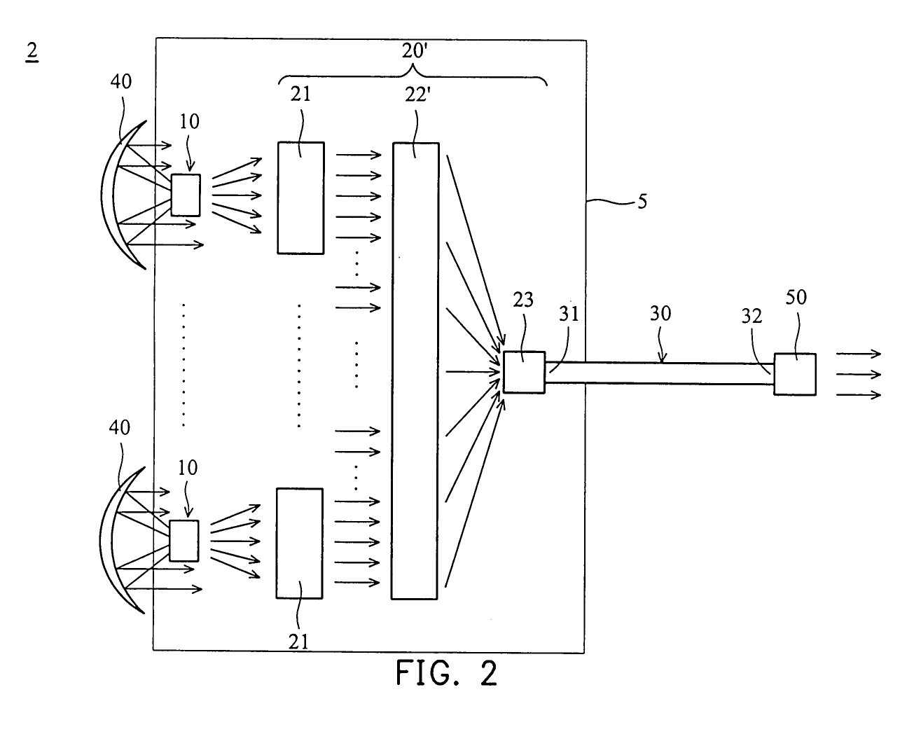

Referring to FIG. 2, the irradiation apparatus 2 comprises a main body 5, a plurality of high power light emitting elements 10, an optical lens assembly 20′ and an optical fiber 30. The high power light emitting elements 10 are disposed on the main body 5. The optical lens assembly 20′ is adjacent to the high power light emitting elements 10 and disposed on the main body 5. The optical fiber 30 has an input end 31 and an output end 32. The input end 31 is coupled to the optical lens assembly 20′.

The optical lens assembly 20′ includes a plurality of first condenser lenses 21, a second condenser lens 22′ and a first convex lens 23. Each first condenser lens 21 is adjacent to one high power light emitting element 10. The second condenser lens 22′ is a larger lens and adjacent to the entire first condenser lenses 21. The first convex lens 23 is adjacent to the second condenser lens 22′. Meanwhile, the first convex lens 23 of the optical lens assembly 20′ is coupled to the input end 31 of the optical fiber 30.

In addition, one reflector 40 is disposed beside each high power light emitting element 10, and a second convex lens 50 is coupled to the output end 32 of the optical fiber 30.

In this embodiment, the high power light emitting element 10 is a high power semiconductor light emitting diode (LED). Since most elements in this embodiment are the same as those in the first embodiment, explanation thereof will be omitted for simplification of the description.

As shown in FIG. 2, light output from each high power semiconductor LED 10 enter the optical lens assembly 20′ directly and by reflected off each corresponding reflector 40. Specifically, some of the light is dispersed before entering the first condenser lens 21. The portion of light managed to pass through each first condenser lens 21 (aspheric condenser lens) enter the second condenser lens 22′ (aspheric condenser lens) and becomes further concentrated. As a whole, the concentrated light beams can be received by the input end 31 of the optical fiber 30 and transmitted via the optical fiber 30. The input end 31 of the optical fiber 30 is coupled to the first convex lens 23 (semi-spherical lens) to increase the light-receiving range of the input end 31 of the optical fiber. The light beams are then output from the output end 32 of the optical fiber 30. The output end 32 of the optical fiber 30 is coupled to the second convex lens 50 (spherical lens) to concentrate the exit light from the second convex lens 50 for photodynamic treatment.

### Third Embodiment

Elements corresponding to those shown in FIG. 1 and FIG. 2 are given the same reference numerals.

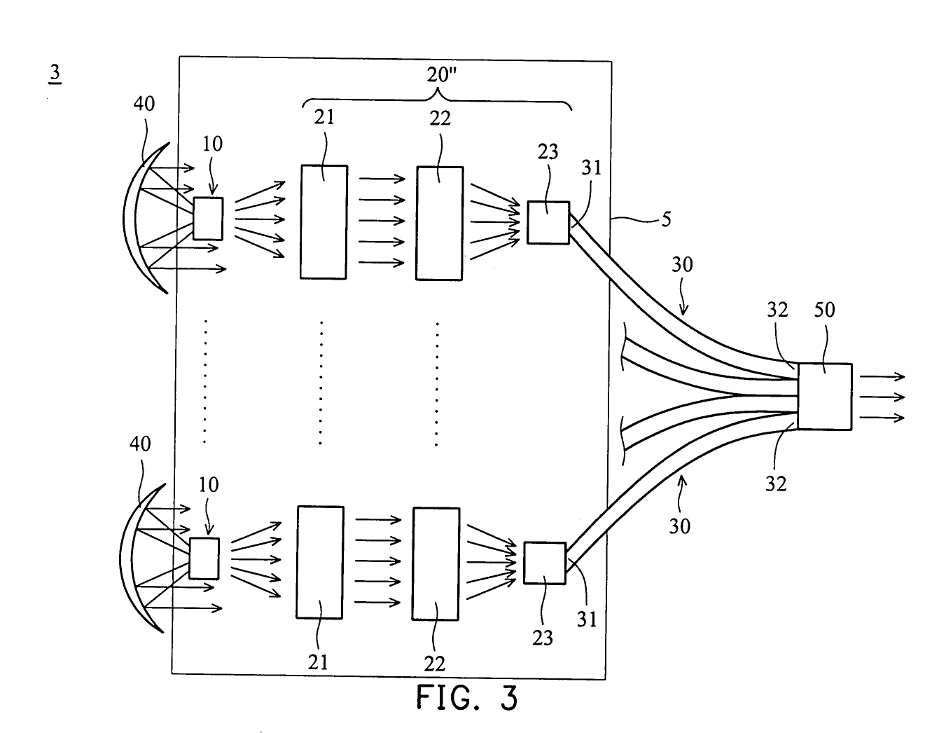

Referring to FIG. 3, the irradiation apparatus 3 comprises a main body 5, a plurality of high power light emitting elements 10, an optical lens assembly 20″ and a plurality of optical fibers 30. The high power light emitting elements 10 are disposed on the main body 5. The optical lens assembly 20″ is adjacent to the high power light emitting elements 10 and disposed on the main body 5. Each optical fiber 30 has an input end 31 and an output end 32. Each input end 31 is coupled to the optical lens assembly 20″.

The optical lens assembly 20″ includes a plurality of first condenser lenses 21, a plurality of second condenser lenses 22 and a plurality of first convex lenses 23. Each first condenser lens 21 is adjacent to each corresponding high power light emitting element 10. Each second condenser lens 22 is adjacent to each corresponding first condenser lens 21. Each first convex lens 23 is adjacent to each corresponding second condenser lens 22. Meanwhile, each first convex lens 23 of the optical lens assembly 20″ is coupled to the input end 31 of each optical fiber 30.

In addition, one reflector 40 is disposed beside each high power light emitting element 10, and a second convex lens 50 is coupled to the output ends 32 of all the optical fibers 30.

In this embodiment, the high power light emitting element 10 is a high power semiconductor light emitting diode (LED). Since most elements in this embodiment are the same as those in the first embodiment, explanation is thereof will be omitted for simplification of the description.

As shown in FIG. 3, when each high power semiconductor LED 10 outputs light beams, the light beams enter the optical lens assembly 20″ directly and by reflection of each corresponding reflector 40. Specifically, some of the light is dispersed before entering the first condenser lens 21. The portion of light managed to pass through each first condenser lens 21 (aspheric condenser lens) enters each second condenser lens 22 (aspheric condenser lens) to become concentrated light beams.

The major difference between this embodiment and the first and second embodiments is that the irradiation apparatus 3 has multiple optical fibers 30. The light beams from each first convex lens 23 are input to each optical fiber 30 via the input end 31 thereof and output to the second convex lens 50 via the output end 32 thereof. The output end 32 of each optical fiber 30 is coupled to the second convex lens 50 (spherical lens) to again concentrate the light beams. At this time, the light beams output from the second convex lens 50 can be employed in a photodynamic treatment.

Additionally, in the aforementioned embodiments, a heat-dissipating element (not shown) may be disposed on the main body 5 to dissipate the heat generated by the irradiation apparatus 1, 2 or 3.

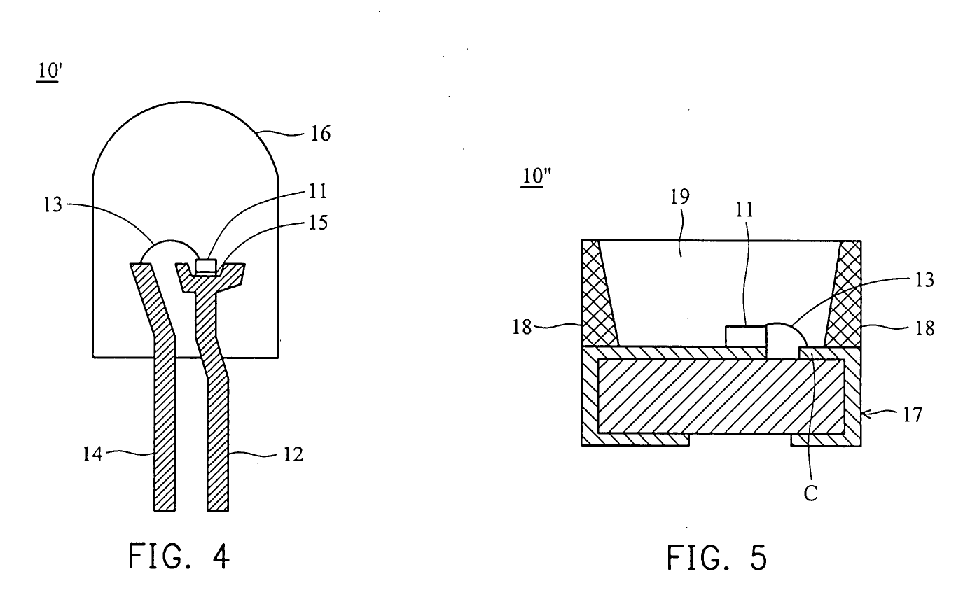

Furthermore, the high power light emitting element 10 can be replaced by the structures shown in FIG. 4 and FIG. 5.

As shown in FIG. 4, the high power light emitting element 10′ includes a high power semiconductor LED die 11, a first leadframe part 12, a wire 13, a second leadframe part 14, a conductive adhesive layer 15 and a packaging element 16. The high power semiconductor LED die 11 is disposed on the first leadframe part 12 and connected to the second leadframe part 14 by the wire 13. The conductive adhesive layer 15 is formed between the first leadframe part 12 and high power semiconductor light emitting diode die 11 and can be made of silver, gold, aluminum, nickel, tin, lead or alloy thereof. The leadframe parts 12 and 14 are made of copper, iron, copper-based alloy and iron-based alloy. The packaging element 16 seals the high power semiconductor light emitting diode die 11, and the leadframe parts 12 and 14.

As shown in FIG. 5, the high power light emitting element 10″ includes a high power semiconductor LED die 11, a wire 13, a printed circuit board or substrate 17 and a packaging element 19. Additionally, the printed circuit board or substrate 17 further includes a conductive circuit C and a reflective wall 18. The conductive circuit C may be formed by deposition. The high power semiconductor LED die 11 is disposed on the printed circuit board or substrate 17 and connected to the conductive circuit C. The reflective wall 18 is formed on the conductive circuit C and embraces the high power semiconductor LED die 11. The high power semiconductor LED die 11 is connected to the conductive circuit C by wire 13. The packaging element 19 seals the is high power semiconductor LED die 11 and printed circuit board or substrate 17.

Accordingly, the packaging elements 16 and 19 may be made of epoxy compound, silicone compound or colloid.

While the invention has been described by way of example and in terms of the preferred embodiments, it is to be understood that the invention is not limited to the disclosed embodiments. In the contrary, it is intended to cover various modifications and similar arrangements (as would be apparent to those skilled in the art). Therefore, the scope of the appended claims should be accorded the broadest interpretation so as to encompass all such modifications and similar arrangements.

1. An irradiation apparatus for a photodynamic treatment, comprising:
a main body;
a high power light emitting element disposed on the main body to output light;
an optical lens assembly adjacent to the high power light emitting element and disposed on the main body to receive the light from the high power light emitting element, wherein the optical lens assembly comprises a first convex lens;
an optical fiber having an input end and an output end, wherein the input end is coupled to the first convex lens of the optical lens assembly to receive and transmit the light from the optical lens assembly; and
a second convex lens coupled to the output end of the optical fiber to concentrate the light from the optical fiber.

2. The irradiation apparatus as claimed in claim 1, wherein the high power light emitting element is a high power semiconductor light emitting diode.

3. The irradiation apparatus as claimed in claim 1, further comprising a reflector disposed beside the high power light emitting element to reflect the light from the high power light emitting element.

4. The irradiation apparatus as claimed in claim 1, wherein the optical lens assembly further comprises a first condenser lens and a second condenser lens, the first condenser lens is adjacent to the high power light emitting element, the second condenser lens is adjacent to the first condenser lens, and the first convex lens is adjacent to the second condenser lens to increase the light-receiving range of the optical fiber.

5. (canceled)

6. The irradiation apparatus as claimed in claim 4, wherein the first condenser lens and second condenser lens are aspheric condenser lenses.

7. The irradiation apparatus as claimed in claim 1, wherein the first convex lens is a semispherical lens.

8. (canceled)

9. The irradiation apparatus as claimed in claim 1, wherein the second convex lens is a spherical lens.

10. The irradiation apparatus as claimed in claim 1, further comprising a heat-dissipating element disposed on the main body.

11. The irradiation apparatus as claimed in claim 1, wherein the high power light emitting element further comprises:
a leadframe having a first leadframe part and a second leadframe part;
a high power semiconductor light emitting diode die disposed on the first leadframe part and connected to the second leadframe part by a wire; and
a packaging element sealing the high power semiconductor light emitting diode die, first and second leadframe parts.

12. The irradiation apparatus as claimed in claim 11, wherein the high power semiconductor light emitting diode die is disposed between the first and second leadframe parts.

13. The irradiation apparatus as claimed in claim 11, wherein the leadframe is made of copper, iron, copper-based alloy and iron-based alloy.

14. The irradiation apparatus as claimed in claim 11, wherein the high power light emitting element further comprises a conductive adhesive layer formed between the first leadframe part and high power semiconductor light emitting diode die.

15. The irradiation apparatus as claimed in claim 14, wherein the conductive adhesive layer is made of silver, gold, aluminum, nickel, tin, lead or alloy thereof.

16. The irradiation apparatus as claimed in claim 11, wherein the packaging element is made of epoxy compound, silicone compound or colloid.

17. The irradiation apparatus as claimed in claim 1, wherein the high power light emitting element further comprises:
a printed circuit board having a conductive circuit and a reflective wall, the reflective wall formed on the conductive circuit, and the conductive circuit formed by deposition;
a high power semiconductor light emitting diode die disposed on the printed circuit board and connected to the conductive circuit; and
a packaging element sealing the high power semiconductor light emitting diode die and printed circuit board.

18. The irradiation apparatus as claimed in claim 17, wherein the packaging element is made of epoxy compound, silicone compound or colloid.

19. The irradiation apparatus as claimed in claim 1, wherein the high power light emitting element further comprises:
a substrate having a conductive circuit and a reflective wall, the reflective wall formed on the conductive circuit, and the conductive circuit formed by deposition the substrate;
a high power semiconductor light emitting diode die disposed on the substrate and connected to the conductive circuit; and
a packaging element sealing the high power semiconductor light emitting diode die and substrate.

20. The irradiation apparatus as claimed in claim 19, wherein the packaging element is made of epoxy compound, silicone compound or colloid.

21. An irradiation apparatus for a photodynamic treatment, comprising:
a main body;
a high power light emitting element disposed on the main body to output light and comprising:
a printed circuit board having a conductive circuit and a reflective wall, the reflective wall formed on the conductive circuit, and the conductive circuit formed by deposition;
a high power semiconductor light emitting diode die disposed on the printed circuit board and connected to the conductive circuit; and
a packaging element sealing the high power semiconductor light emitting diode die and printed circuit board;
an optical lens assembly adjacent to the high power light emitting element and disposed on the main body to receive the light from the high power light emitting element; and
an optical fiber having an input end and an output end, wherein the input end is coupled to the optical lens assembly to receive and transmit the light from the optical lens assembly.

22. An irradiation apparatus for a photodynamic treatment, comprising:
a main body;
a high power light emitting element disposed on the main body to output light and comprising:
a substrate having a conductive circuit and a reflective wall, the reflective wall formed on the conductive circuit, and the conductive circuit formed by deposition the substrate;
a high power semiconductor light emitting diode die disposed on the substrate and connected to the conductive circuit; and
a packaging element sealing the high power semiconductor light emitting diode die and substrate;
an optical lens assembly adjacent to the high power light emitting element and disposed on the main body to receive the light from the high power light emitting element; and
an optical fiber having an input end and an output end, wherein the input end is coupled to the optical lens assembly to receive and transmit the light from the optical lens assembly.
